(19) United States
(12) Patent Application Publication
(10) Pub. No.: US 2017/0351096 A1
(43) Pub. Date: Dec. 7, 2017

(54) HEAD-MOUNTED EQUIPMENT CAPABLE OF DISPLAYING IMAGES

(71) Applicant: Cheng-Ho Tsai, Changhua County (TW)

(72) Inventor: Cheng-Ho Tsai, Changhua County (TW)

(21) Appl. No.: 15/608,977

(22) Filed: May 30, 2017

(30) Foreign Application Priority Data
Jun. 1, 2016 (TW) 105117281
Jun. 7, 2016 (TW) 105118042

(51) Int. Cl. G02B 27/01

(52) U.S. Cl. CPC G02B 27/0172; G02B 27/0149; G02B 27/0176; G02B 2027/015; G02B 27/017; G02B 2027/0169; G02B 2027/0196; G02B 2027/013

(57) ABSTRACT

A head-mounted equipment capable of displaying images includes: a head-worn member, a visor, a face-worn member and a display. The head-worn member has a front edge, and the visor is attached to the front edge of the head-worn member and is partially reflective and partially transparent. The face-worn member has a wearing surface and an opposite mounting surface, and the display is mounted on the mounting surface of the face-worn member to project an image to the visor.

### BACKGROUND OF THE INVENTION

### Field of the Invention

The present invention relates to a head-mounted equipment, and more particularly to a head-mounted equipment capable of displaying images.

### Related Prior Art

A conventional cap-type HUD (head up display) includes: a cap, a reflector and an imaging module. The cap has a peak, and the reflector is pivotally disposed at the front edge of the peak. The reflector is partially reflective and partially transparent. The imaging module is removably attached to the lower surface of the peak, by way of magnetic attraction, adhesive or clipping, to project an image to the reflector, and via the reflector, the image is reflected to a user's eyes.

The imaging module is attached to the lower surface of the peak and will protrude from the lower surface of the peak, and as a result, when the cap is worn on the head, the imaging module is likely to hit or interfere with the user's head, or block the user's vision. Therefore, the above cap-type HUD still has room for improvement.

The present invention has arisen to mitigate and/or obviate the afore-described disadvantages.

### SUMMARY

One objective of the present invention is to provide a head-mounted equipment capable of displaying images, wherein the display will neither interfere with the head of the user nor block the vision of the user.

To achieve the above objective, a head-mounted equipment capable of displaying images in accordance with the present invention, includes: a head-worn member with a front edge; a visor attached to the front edge of the head-worn member, and being partially reflective and partially transparent, wherein the visor is arc-shaped and has a concave surface and a convex surface; a face-worn member with a wearing surface and an opposite mounting surface; and a display mounted on the mounting surface of the face-worn member to project an image to the visor.

The display of the head-mounted equipment of the invention is attached to the face-worn member, unlike the prior art in which the imaging module is attached to the lower surface of the peak of the cap. When in use, the face-worn member is attached to the face of the user, so that the displays will neither interfere with the head of the user nor block the vision of the user, which facilitates the user to see the images.

Still, to achieve the above objective, a head-mounted equipment capable of displaying images in accordance with the present invention, includes: a head-worn member with a front edge; a visor attached to the front edge of the head-worn member, and being partially reflective and partially transparent, wherein the visor is arc-shaped; at least one bracket with a fixing end and at least one connecting end, wherein the fixing end is fixed to the visor, and the at least one bracket extends from the fixing end toward a direction away from the visor to form the at least one connecting end; and a display mounted on the at least one connecting end of the at least one bracket to project an image to the visor.

The at least one bracket is mounted on the visor, unlike the prior art in which the imaging module is attached to the lower surface of the peak of the cap. When in use, the head-worn member is worn on the head of the user, so that the display will neither interfere with the head of the user nor block the vision of the user, which facilitates the user to see the images.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an illustrative view of the head-mounted equipment in accordance with a first preferred embodiment of the present invention, showing that the head-worn member is worn on the user's head;

FIG. 2 is an exploded view in accordance with the first preferred embodiment of the present invention, wherein the visor is separated from the head-worn member;

FIG. 3 is a perspective view in accordance with the first preferred embodiment of the present invention, showing that the displays are disposed on the face-worn member;

FIG. 4 is a cross sectional view taken along the line 4-4 of FIG. 3;

FIG. 5 is an illustrative view of the invention, showing the wire electrical connection between the display and the image source device;

FIG. 6 is an illustrative view of the invention, showing the wireless electrical connection between the display and the image source device;

FIG. 7 is an illustrative view of the head-mounted equipment of the first preferred embodiment of the invention, showing another embodiment of the head-worn member;

FIG. 8 is a perspective view of a head-mounted equipment in accordance with a second preferred embodiment of the present invention, showing that the displays are disposed on the face-worn member;

FIG. 9 is an operational view of the head-mounted equipment in accordance with the second preferred embodiment of the present invention;

FIG. 10 is a perspective view of a head-mounted equipment in accordance with a third preferred embodiment of the present invention, showing that the displays are disposed on the face-worn member;

FIG. 11 is a cross sectional view taken along the line 11-11 of FIG. 10;

FIG. 12 is a perspective view of a head-mounted equipment in accordance with a fourth preferred embodiment of the present invention, showing that two legs are coupled to the face-worn member;

FIG. 13 is a perspective view of a head-mounted equipment in accordance with a fifth preferred embodiment of the present invention, showing that two rope rings are coupled to the face-worn member;

FIG. 14 is a perspective view of the face-worn member of the head-mounted equipment in accordance with a sixth preferred embodiment of the present invention;

FIG. 15 is a cross sectional view taken along the line 15-15 of FIG. 14;

FIG. 16 is an illustrative view of the head-mounted equipment of the sixth preferred embodiment of the invention, showing another embodiment of the head-worn member;

FIG. 17 is an operational view of the head-mounted equipment in accordance with a seventh preferred embodiment of the present invention, showing that the head-worn member is worn on the user's head;

FIG. 18 is an operational view of the head-mounted equipment in accordance with an eighth preferred embodiment of the present invention, illustrating the adjustment of the bracket;

FIG. 19 is an exploded view of the head-mounted equipment in accordance with the seventh preferred embodiment of the present invention;

FIG. 20 is an illustrative view of the invention, showing the wire electrical connection between the display and the image source device;

FIG. 21 is an illustrative view of the invention, showing the wireless electrical connection between the display and the image source device;

FIG. 22 is an illustrative view of the head-mounted equipment of the seventh preferred embodiment of the invention, showing another embodiment of the head-worn member;

FIG. 23 is an illustrative view of the head-mounted equipment of an eighth preferred embodiment of the invention, showing that there are three displays mounted on three connecting ends of one bracket;

FIG. 24 is an illustrative view of the head-mounted equipment of a ninth preferred embodiment of the invention, showing that there are two displays mounted on two connecting ends of total two brackets; and

FIG. 25 is an illustrative view of the head-mounted equipment of a tenth preferred embodiment of the invention, showing that there are four displays mounted on four connecting ends of total two brackets.

### DETAILED DESCRIPTION

The present invention will be clearer from the following description when viewed together with the accompanying drawings, which show, for purpose of illustrations only, the preferred embodiment in accordance with the present invention.

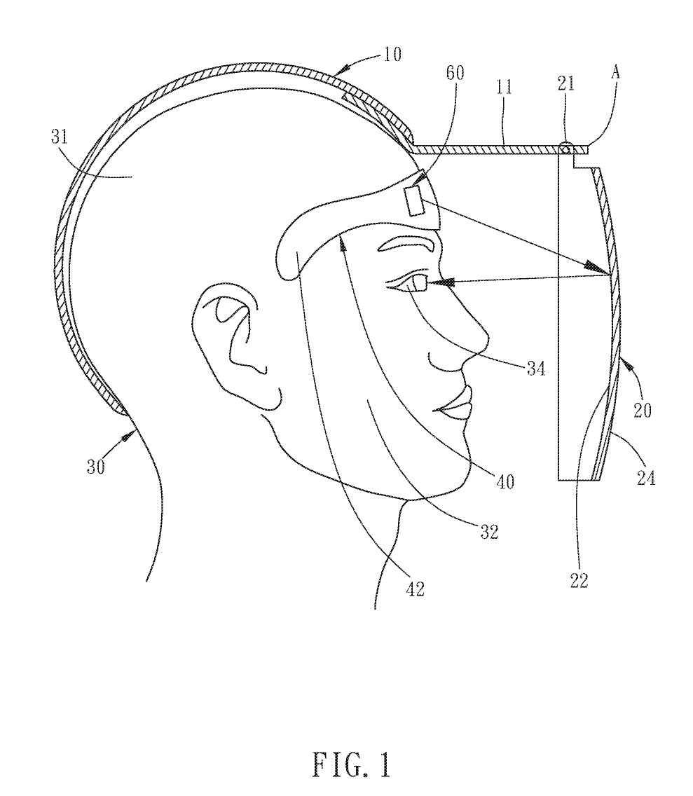

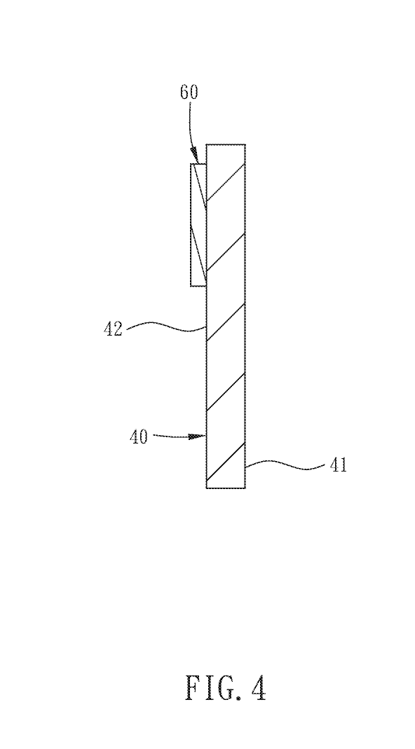

Referring to FIGS. 1-6, a head-mounted equipment capable of displaying images in accordance the first preferred embodiment of the present invention, includes: a head-worn member 10, a visor 20, a face-worn member 40 and two displays 60.

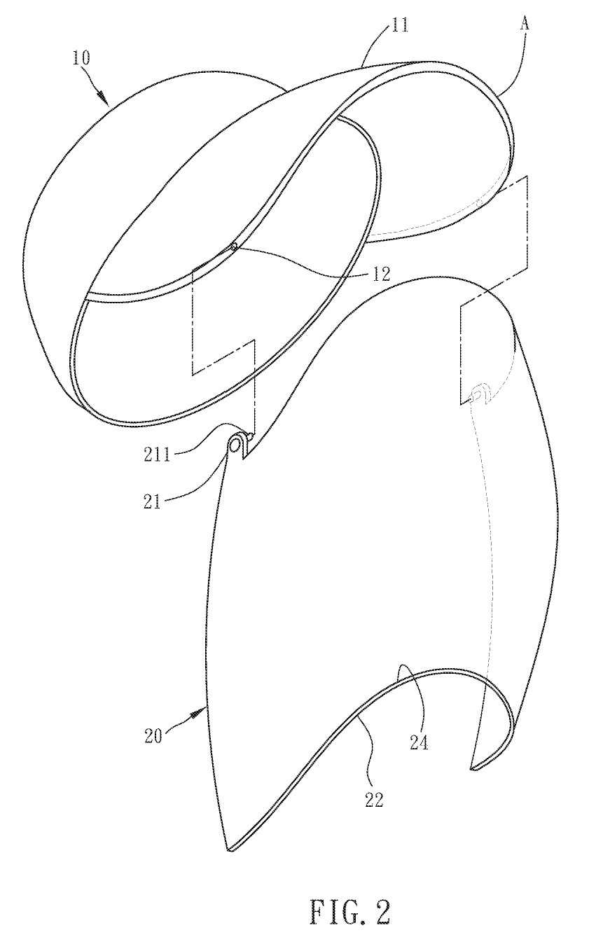

Referring to FIGS. 1 and 2, the head-worn member 10 has a front edge A. In this embodiment as shown in FIG. 2, the head-worn member 10 is a baseball cap 10 which has a peak 11, and at two sides of the front edge A of the peak 11 are disposed two pivot holes 12.

The visor 20 is attached to the front edge A of the baseball cap 10, and is partially reflective and partially transparent, as shown in FIG. 2. In this embodiment, the visor 20 is provided at two ends of the top edge thereof with two pivot ears 21, and each of the pivot ears 21 has a protrusion 211 inserted into the pivot holes 12 of the baseball cap 10, so that the visor 20 is pivotally attached to two sides of the peak 11. The two pivot ears 21 of the visor 20 are clamped against and produce friction with respect to the two sides of the peak 11, so that the visor 20 can be pivotally positioned with respect to the baseball cap 10. Moreover, the visor 20 is approximately arc-shaped and has a concave surface 22 and a convex surface 24, and the concave surface 22 is located toward the baseball cap 10.

Referring then to FIGS. 1, 3 and 4, the face-worn member 40 is a flexible piece with a wearing surface 41 and an opposite mounting surface 42. The wearing surface 41 is made of a material, like silicone rubber, in order to have a sticky property, and as a result, the wearing surface 41 of the face-worn member 40 can be removably attached to the face 32 of a user 30.

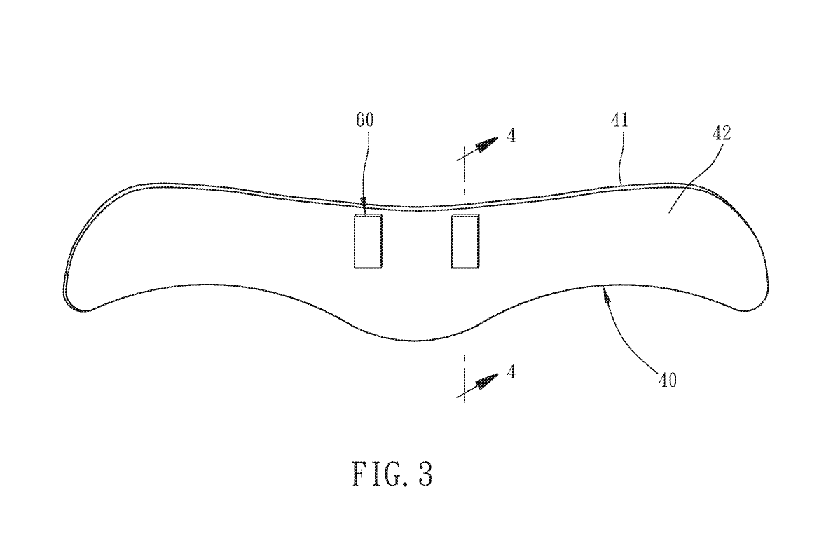

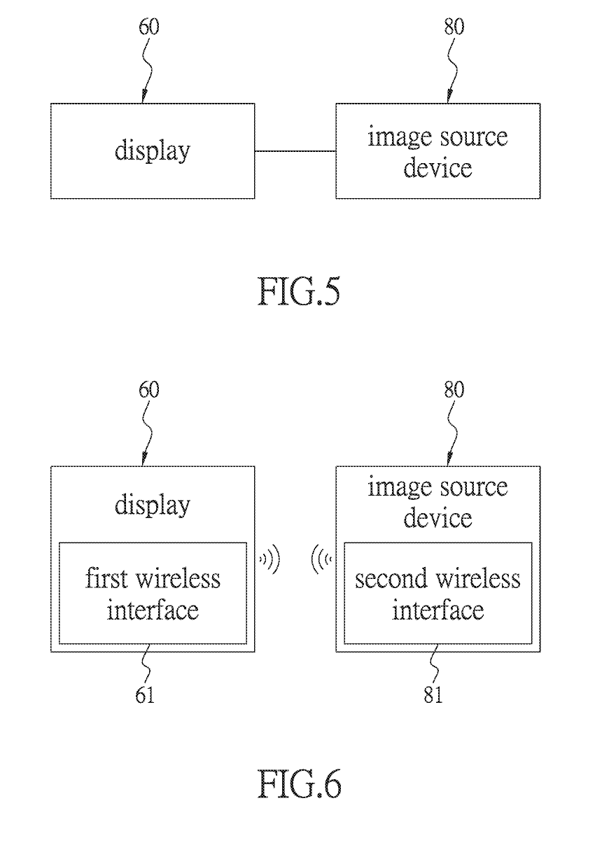

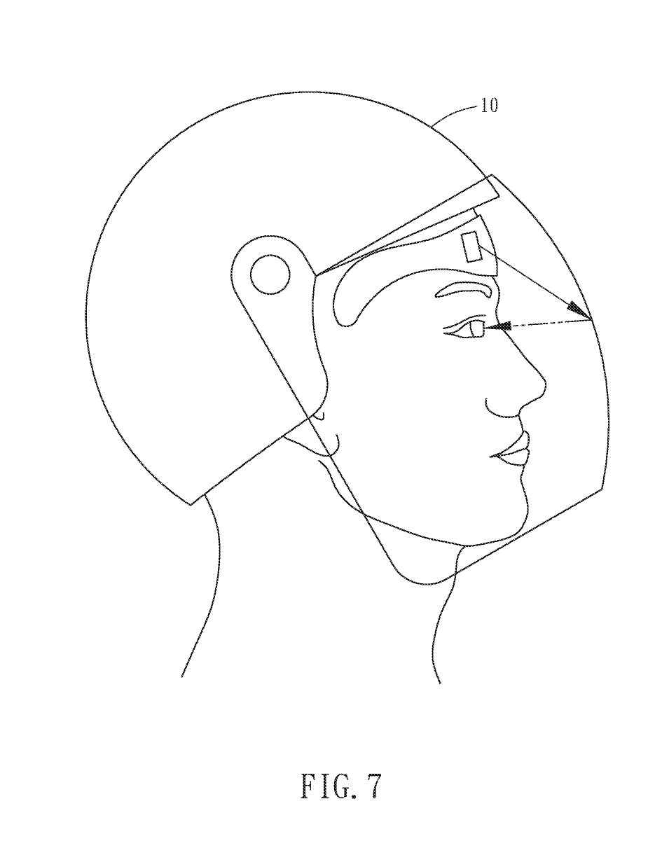

As shown in FIG. 3, the displays 60 are mounted on the mounting surface 42 of the face-worn member 40. In this embodiment, the displays 60 are LCD (liquid crystal display). As shown in FIG. 5, when in use, the displays 60 are connected to an image source device 80 by a wire (not shown). The image source device 80 can be mounted on the baseball cap 10 to send an image signal (not shown) to each of the displays 60, so as to produce an image on the displays 60. As shown in FIG. 6, the displays 60 are electrically connected to the image source device 80 in a wireless manner. The image source device 80 is a smart phone (not shown) which can be held by the user 30. To achieve wireless connection, the displays 60 each include a first wireless interface 61, and the image source device 80 includes a second wireless interface 81, so that the displays 60 and the image source device 80 are electrically connected via wireless frequency through the first and second wireless interfaces 61, 81, and the image source device 80 can send an image signal (not shown) to each of the displays 60, so as to produce an image on the displays 60.

What mentioned above is the structure of the first preferred embodiment, and what follows is the description of the use of the first preferred embodiment.

Referring to FIGS. 1-5, when in use, the wearing surface 41 of the face-worn member 40 can be attached to the face 32 of the user 30, and then the baseball cap 10 is worn on the head 31 of the user 30. By pivoting the visor 20, the concave surface 22 is turned toward the face 32 of the user 30. At this moment, the two pivot ears 21 of the visor 20 are clamped against two sides of the peak 11, and the displays 60 are located toward the concave surface 22 of the visor 20, so that the images sent from the image source device 80 can be projected onto the visor 20 by the displays 60, and then are directly reflected by the visor 20 to the eyes 34 of the user 30. At this moment, the user 30 can adjust the position of the reflected images by pivoting the visor 20, so as to better display the images. Meanwhile, the user 30 is also able to see outside scenery through the visor 20.

It can be learned from the above description that the effect of this invention is that: it solves the problem of the prior art that the imaging module is attached to and will protrude from the lower surface of the peak, and as a result, when the cap is worn on the head, the imaging module is likely to interfere with the user's head, or block the user's vision. The displays 60 of the head-mounted equipment of the invention are attached to the face-worn member 40, unlike the prior art in which the imaging module is attached to the lower surface of the peak 11 of the cap. When in use, the face-worn member 40 is attached to the face 32 of the user 30, so that the displays 60 will neither interfere with the head 31 of the user 30 nor block the vision of the user 30, which facilitates the user 30 to see the images.

It is to be noted that the arc-shaped visor 20 can have a spherical shape, and the concave surface 22 is also spherical shaped. The displays 60 are disposed at reversed phase positions (or opposite to) to the visor 20, and the visor 20 is arc-shaped and the displays 60 are disposed at the reversed phase projection positions of the face-worn member 40, which allows the projection content from the displays 60 to be projected more accurately to the user's eyes, without using extra image correction lenses. Hence, the structure of the displays 60 is simplified to reduce the cost.

There are two displays 60 in the above embodiment, which is for exemplary purposes only and not for limiting, and there can also be only one display 60.

Referring to FIG. 2 again, the two pivot ears 21 of the visor 20 are clamped against and produce friction with respect to the two sides of the peak 11, so that the visor 20 can be pivotally positioned with respect to the baseball cap 10, which, however, does not intend to limit the invention. For example, the two pivot ears 21 of the visor 20 are just pivotally disposed at two sides of the peak 11 without clamping against the two sides of the peak 11, so that the visor 20 is able to pivot about the baseball cap 10 but cannot be positioned. As long as the visor 20 can pivot, the image from the display 60 can be projected onto the visor 20. Since the forgoing is understandable from the first preferred embodiment, it is no longer depicted in drawings again.

Moreover, the visor 20 is not limited to being pivoted to the peak 11 of the baseball cap 10. In fact, the visor 20 can also be fixed to the peak 11 of the baseball cap 10, as long as the image from the display 60 can be projected onto the visor 20.

In the above description, the head-worn member 10 is a baseball cap 10, which is not provided for limiting purposes, and the head-worn member 10 can also be a safety helmet 10, as shown in FIG. 7.

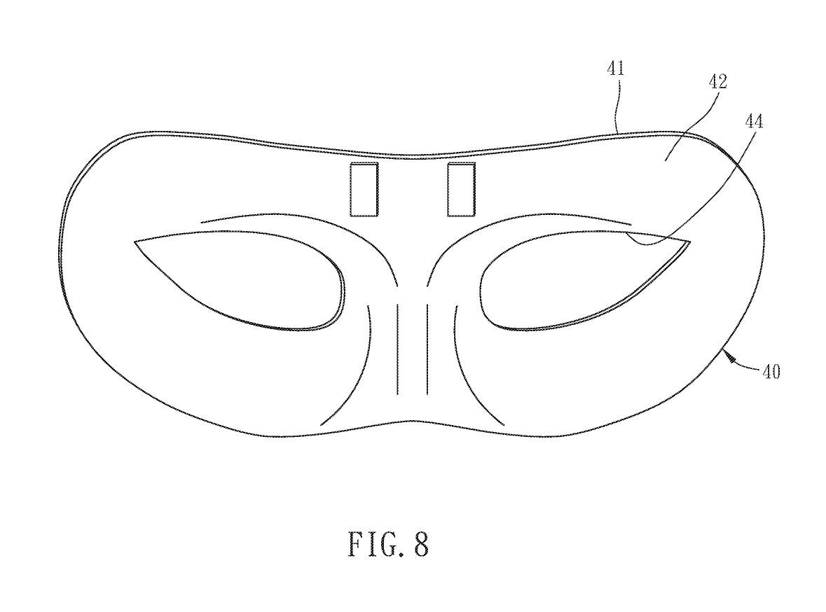

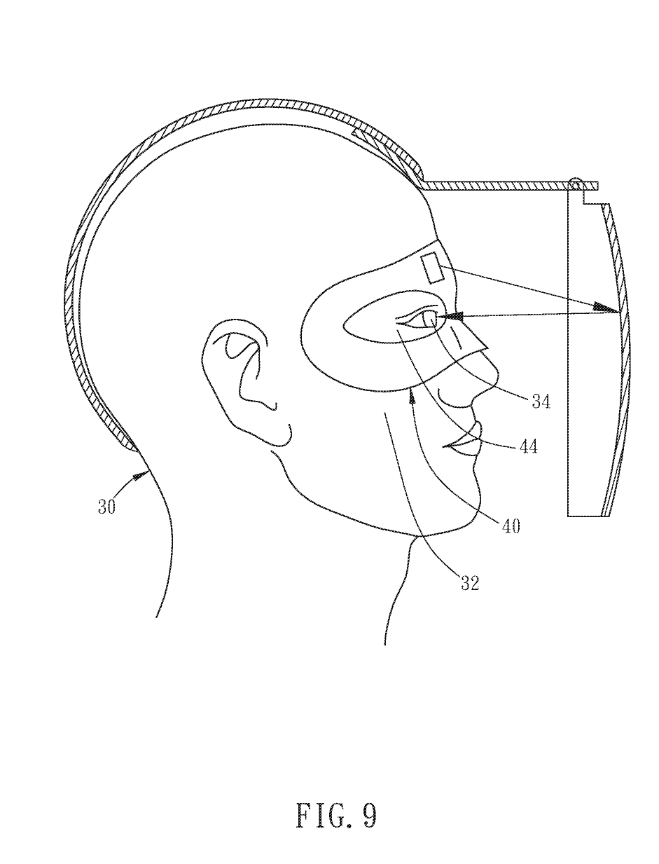

Referring then to FIGS. 8 and 9, a head-mounted equipment capable of displaying images in accordance the second preferred embodiment of the present invention is similar to the first preferred embodiment, except that:

The face-worn member 40 is provided with two see-through apertures 44, and the eyes 34 of the user 30 are aligned with the two see-through apertures 44 to receive the image reflected from the visor 20.

The rest structures of the second preferred embodiment are the same as the first preferred embodiment, and therefore, no further description seems necessary.

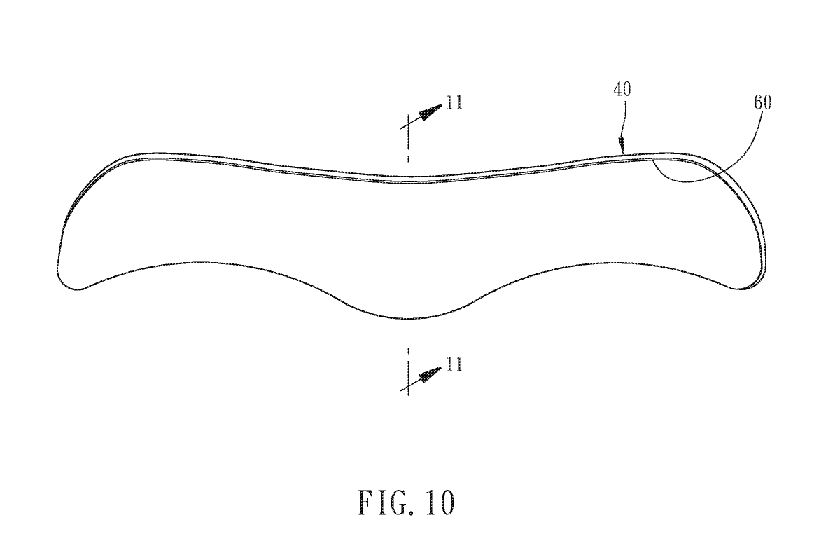

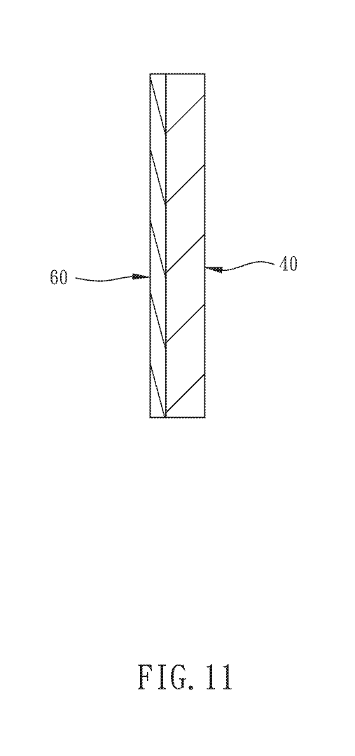

Referring then to FIGS. 10 and 11, a head-mounted equipment capable of displaying images in accordance the third preferred embodiment of the present invention is similar to the first preferred embodiment, except that:

There is only one display 60, and the display 60 is configured to conform to the shape of the face-worn member 40. Therefore, the display 60 has a relatively large display area.

The rest structures of the third preferred embodiment are the same as the first preferred embodiment, and therefore, no further description seems necessary.

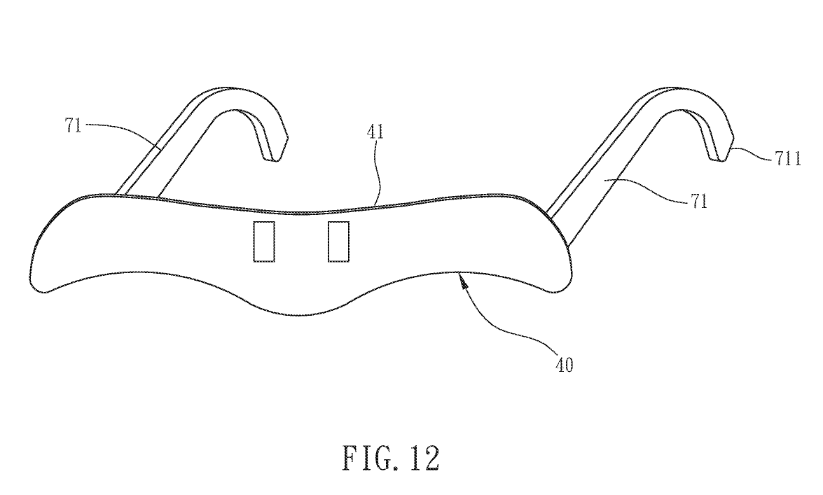

Referring then to FIG. 12, a head-mounted equipment capable of displaying images in accordance with the fourth embodiment of the present invention is similar to the first preferred embodiment, except that:

Two ear-hook members 71 are provided at two sides of the face-worn member 40. In this embodiment, the two ear-hook members 71 are two legs 71, each of the two legs 71 has one end connected to two sides of the face-worn member 40, and has another end formed with a hook portion 711 to be hooked to the ears of the user 30. Therefore, without having to be sticky or without having to abut against the face 32 of the user 30, the wearing surface 41 of the face-worn member 40 can also be attached or fixed to the face 32 of the user 30,

The rest structures of the fourth preferred embodiment are the same as the first preferred embodiment, and therefore, no further description seems necessary.

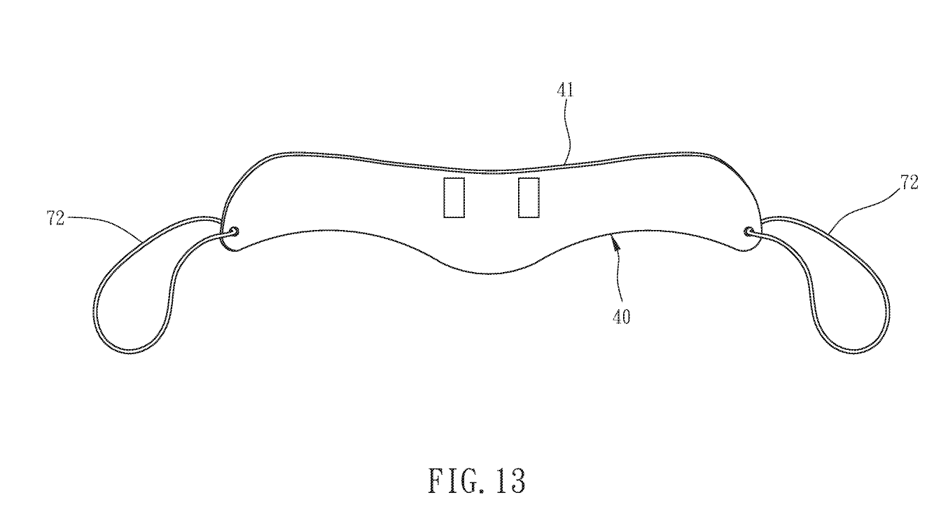

Referring then to FIG. 13, a head-mounted equipment capable of displaying images in accordance with the fifth embodiment of the present invention is similar to the first preferred embodiment, except that:

the two ear-hook members 72 are two rope rings 72 which are connected to two sides of the face-worn member 40 and to be hooked to the ears of the user 30. Therefore, the wearing surface 41 of the face-worn member 40 can also be attached or fixed to the face 32 of the user 30, without having to be sticky.

The rest structures of the fifth preferred embodiment are the same as the first preferred embodiment, and therefore, no further description seems necessary.

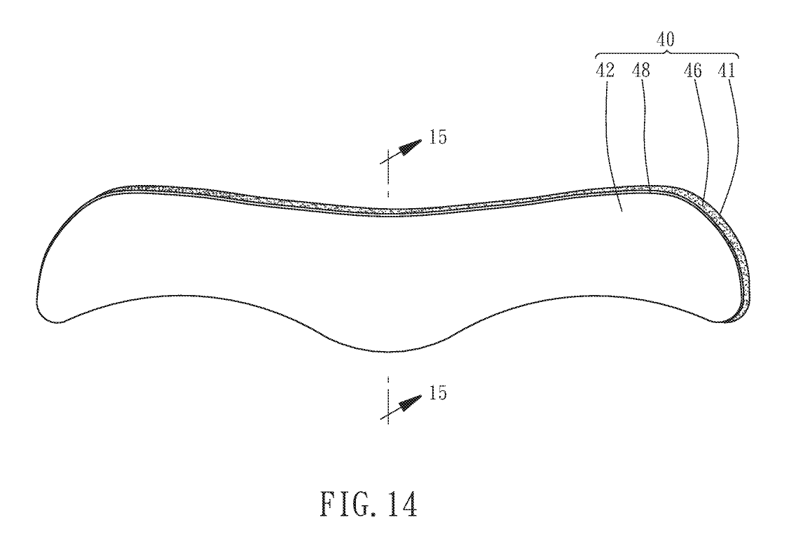

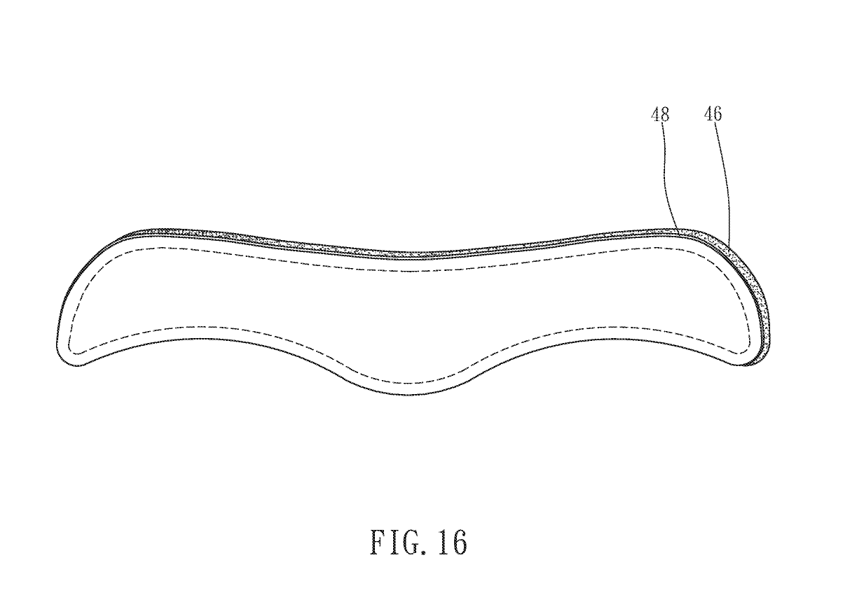

Referring then to FIGS. 14-16, a head-mounted equipment capable of displaying images in accordance with the sixth embodiment of the present invention is similar to the first preferred embodiment, except that:

The face-worn member 40 includes an abutting layer 46 and a substrate 48. The abutting layer 46 is made of silicone rubber with a sticky property. The substrate 48 is provided for mounting of the displays 60 (as shown in FIG. 1). In this embodiment, the outer surface of the abutting layer 46 is provided with the wearing surface 41, and the outer surface of the substrate 48 is provided with the mounting surface 42.

When in use, the abutting layer 46 of the face-worn member 40 is abutted against the face 32 of the user 30, and the abutting layer 46 is able to be firmly attached to the face 32 of the user 30. In this embodiment, the abutting layer 46 of the face-worn member 40 is made of (but not limited to) silicone rubber, as long as the abutting layer 46 has sticky property and can be removably attached to the face 32 of the user 30.

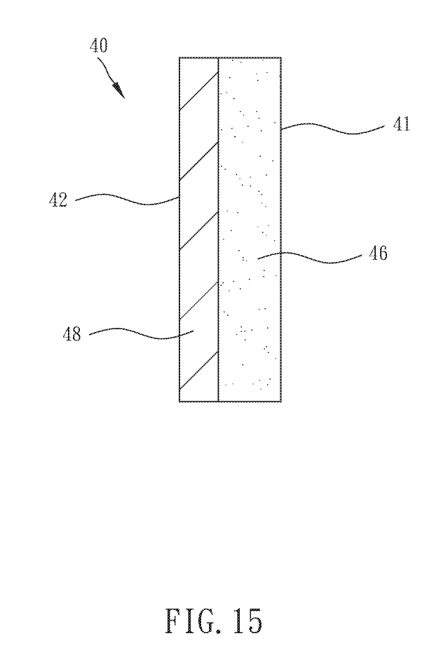

As shown in FIGS. 14 and 15, the abutting layer 46 is shaped to conform to the shape of the substrate 48, and can also have a shape different from the shape of the shape of the substrate 48, as along as the abutting layer 46 can be firmly attached to the face 32 of the user 30.

The rest structures of the sixth preferred embodiment are the same as the first preferred embodiment, and therefore, no further description seems necessary.

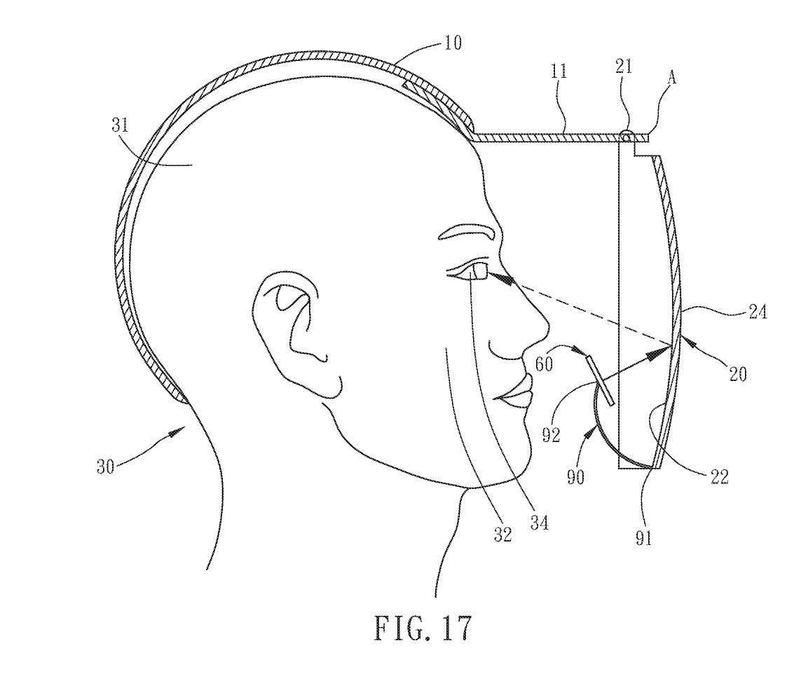

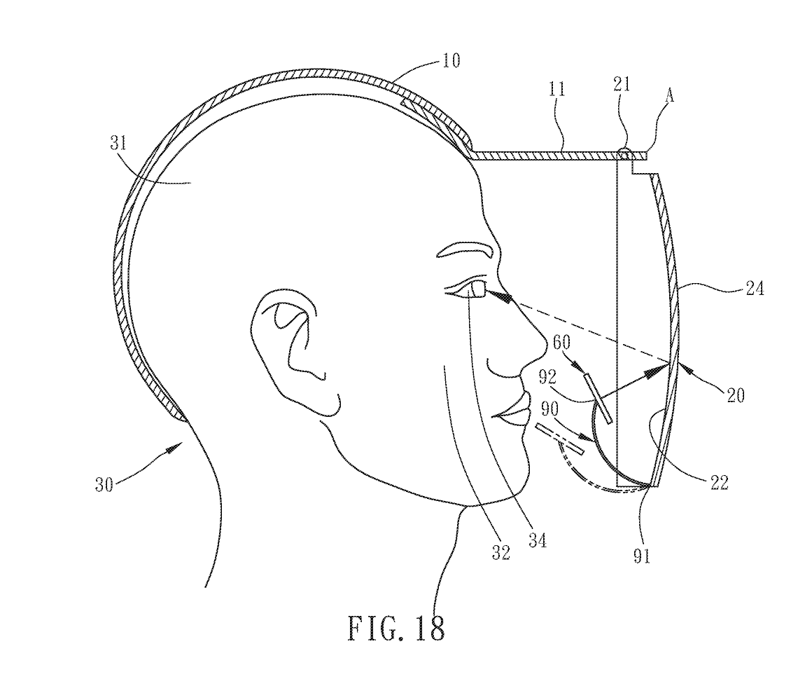

Referring then to FIGS. 17-19, a head-mounted equipment capable of displaying images in accordance with the seventh embodiment of the present invention includes: a head-worn member 10, a visor 20, at least one bracket 90 and at least one display 60.

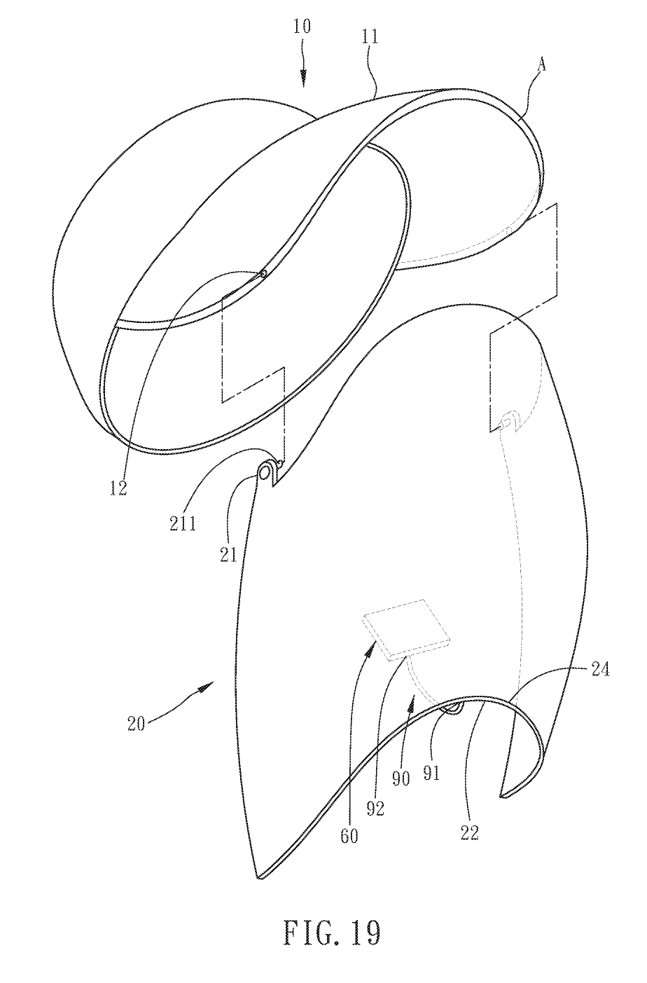

The head-worn member 10 has a front edge A. In this embodiment as shown in FIG. 19, the head-worn member 10 is a baseball cap 10 which has a peak 11, and at two sides of the front edge A of the peak 11 are disposed two pivot holes 12.

The visor 20 is attached to the front edge A of the baseball cap 10, and is partially reflective and partially transparent, as shown in FIG. 19. In this embodiment, the visor 20 is provided at two ends of the top edge thereof with two pivot ears 21, and each of the pivot ears 21 has a protrusion 211 inserted into the pivot holes 12 of the baseball cap 10, so that the visor 20 is pivotally attached to two sides of the peak 11. The two pivot ears 21 of the visor 20 are clamped against and produce friction with respect to the two sides of the peak 11, so that the visor 20 can be pivotally positioned with respect to the baseball cap 10. Moreover, the visor 20 is approximately arc-shaped and has a first surface 22 and an opposite second surface 24, and the first surface 22 is located toward the baseball cap 10. The first surface 22 is a concave surface 22 and the second surface 24 is a convex surface 24.

The at least one bracket 90 has a fixing end 91 and at least one connecting end 92. The fixing end 91 is fixed to the visor 20, and the bracket 90 extends from the fixing end 91 toward a direction away from the visor 20 to form the at least one connecting end 92. In this embodiment, the bracket 90 has flexibility, and there is one bracket 90 as exemplary. Besides, the bracket 90 has one connecting end 92 as exemplary, and the fixing end 91 of the at least one bracket 90 is disposed at the first surface 22 of the visor 20.

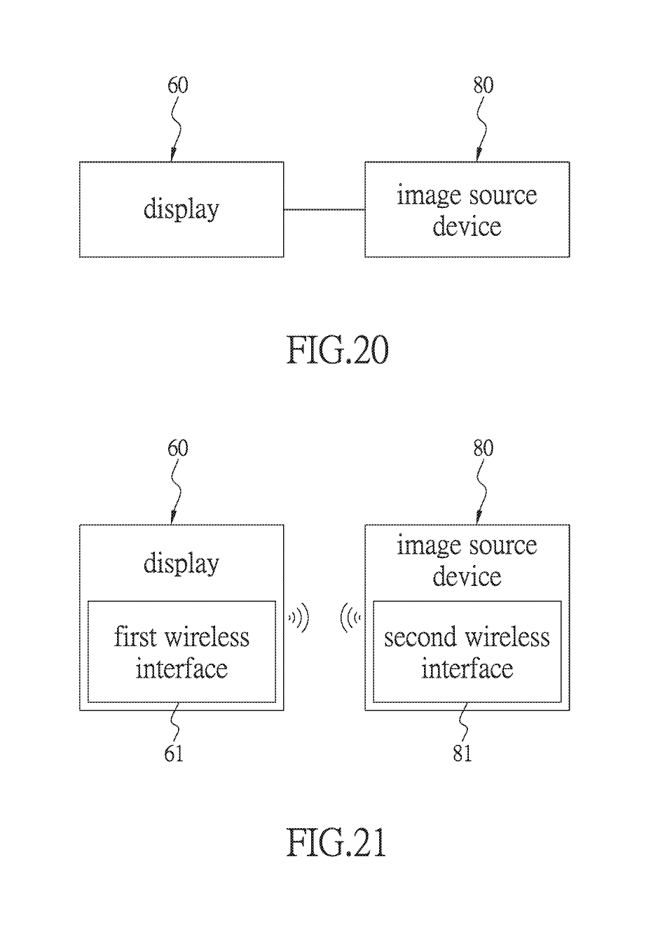

The at least one display 60 is disposed at the at least one connecting end 92 of the bracket 90 to project an image to the visor 20. In this embodiment, there is one display 60, and the display 60 is a LCD. As shown in FIG. 20, when in use, the display 60 is connected to an image source device 80 by a wire (not shown). The image source device 80 can be mounted on the baseball cap 10 to send an image signal (not shown) to the display 60, so as to produce an image on the display 60. As shown in FIG. 21, the display 60 is electrically connected to the image source device 80 in a wireless manner. The image source device 80 is a smart phone (not shown) which can be held by the user 30. To achieve wireless connection, the display 60 includes a first wireless interface 61, and the image source device 80 includes a second wireless interface 81, so that the display 60 and the image source device 80 are electrically connected via wireless frequency through the first and second wireless interfaces 61, 81, and the image source device 80 can send an image signal (not shown) to each of the display 60, so as to produce an image on the display 60.

What mentioned above is the structure of the seventh preferred embodiment, and what follows is the description of the use of the seventh preferred embodiment.

Referring to FIGS. 17-19, when in use, the baseball cap 10 is worn on the head 31 of the user 30. By pivoting the visor 20, the first surface 22 is turned toward the face 32 of the user 30. At this moment, the two pivot ears 21 of the visor 20 are clamped against two sides of the peak 11, and the display 60 is located toward the first surface 22 of the visor 20, so that the images sent from the image source device 80 can be projected onto the visor 20 by the display 60, and then are directly reflected by the visor 20 to the eyes 34 of the user 30. At this moment, the user 30 can adjust the projection angle of the images of the display 60 by adjusting the flexible bracket 90, so as to better display the images. Meanwhile, the user 30 is also able to see outside scenery through the visor 20.

It can be learned from the above description that the effect of this invention is that: it solves the problem of the prior art that the imaging module is attached to and will protrude from the lower surface of the peak, and as a result, when the cap is worn on the head, the imaging module is likely to interfere with the user's head, or block the user's vision. The at least one bracket 90 is mounted to the visor 20, and the at least one display 60 is mounted on the at least one bracket 90, unlike the prior art in which the imaging module is attached to the lower surface of the peak 11 of the cap. When in use, the head-worn member 10 is worn on the head 31 of the user 30, so that the display 60 will neither interfere with the head 31 of the user 30 nor block the vision of the user 30, which facilitates the user 30 to see the images.

Referring to FIG. 19 again, the two pivot ears 21 of the visor 20 are clamped against and produce friction with respect to the two sides of the peak 11, so that the visor 20 can be pivotally positioned with respect to the baseball cap 10, which, however, does not intend to limit the invention. For example, the two pivot ears 21 of the visor 20 are just pivotally disposed at two sides of the peak 11 without clamping against the two sides of the peak 11, so that the visor 20 is able to pivot about the baseball cap 10 but cannot be positioned. As long as the visor 20 can pivot, and the image from the display 60 can be projected onto the visor 20. Since the forgoing is understandable from the first preferred embodiment, it is no longer depicted in drawings again.

Moreover, the visor 20 is not limited to being pivoted to the peak 11 of the baseball cap 10. In fact, the visor 20 can also be fixed to the peak 11 of the baseball cap 10, as long as the image from the display 60 can be projected onto the visor 20.

Besides, the bracket 90 of the present invention is not to being flexible. In fact, the bracket 90 can also be inflexible, as long as the display 60 can be mounted on the at least one connecting end 92 of the bracket 90 to allow direct reflection of the image from the display 60 onto the eyes 34 of the user 30 by the visor 20.

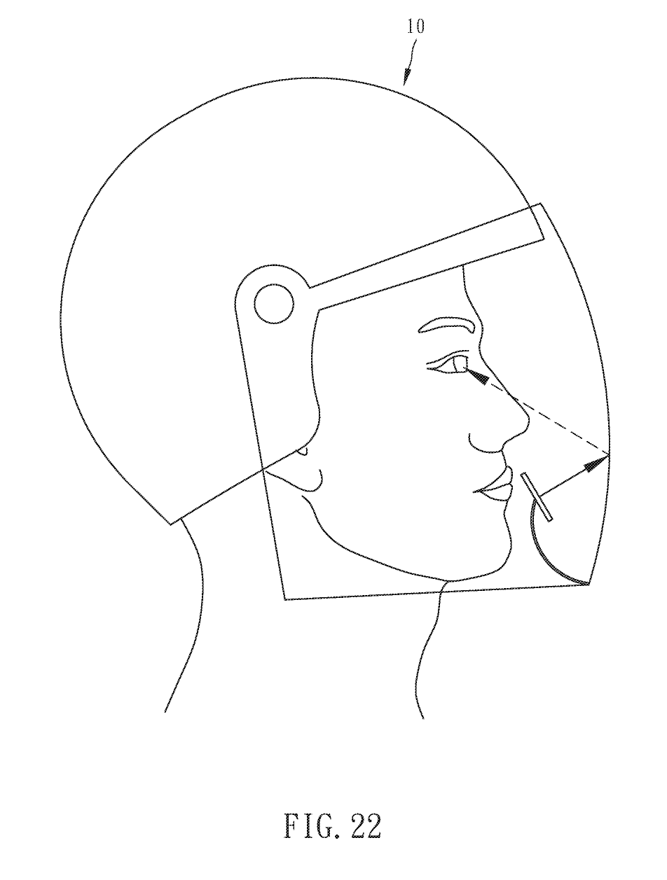

In the above description, the head-worn member 10 is a baseball cap 10, which is not provided for limiting purposes, and the head-worn member 10 can also be a safety helmet 10, as shown in FIG. 22.

It is to be noted that the arc-shaped visor 20 can have a spherical shape, and the concave surface 22 is also spherical shaped. The display 60 is disposed at reversed phase positions to the visor 20, and the visor 20 is arc-shaped and the display 60 is disposed at the reversed phase projection positions of the face-worn member 40, which allows the projection content from the display 60 to be projected more accurately to the user's eyes, without using extra image correction lenses. Hence, the structure of the display 60 is simplified to reduce the cost.

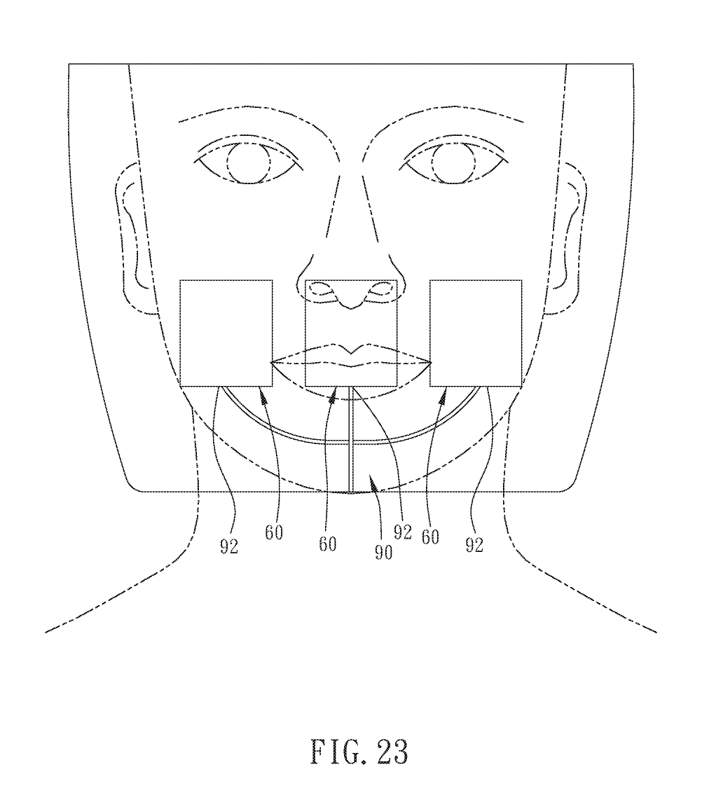

Referring then to FIG. 23, a head-mounted equipment capable of displaying images in accordance with the eighth embodiment of the present invention is similar to the seventh preferred embodiment, except that:

The quantity of the at least one connecting end 92 of the bracket 90 is plural. In this embodiment, the quantity of the at least one connecting end 92 of the bracket 90 is three as exemplary, the quantity of the at least one display 60 is also three, and the three displays 60 are mounted on the three connecting ends 92 of the bracket 90 to achieve the effect of projecting more images.

The rest structures of the eighth preferred embodiment are the same as the seventh preferred embodiment, and therefore, no further description seems necessary.

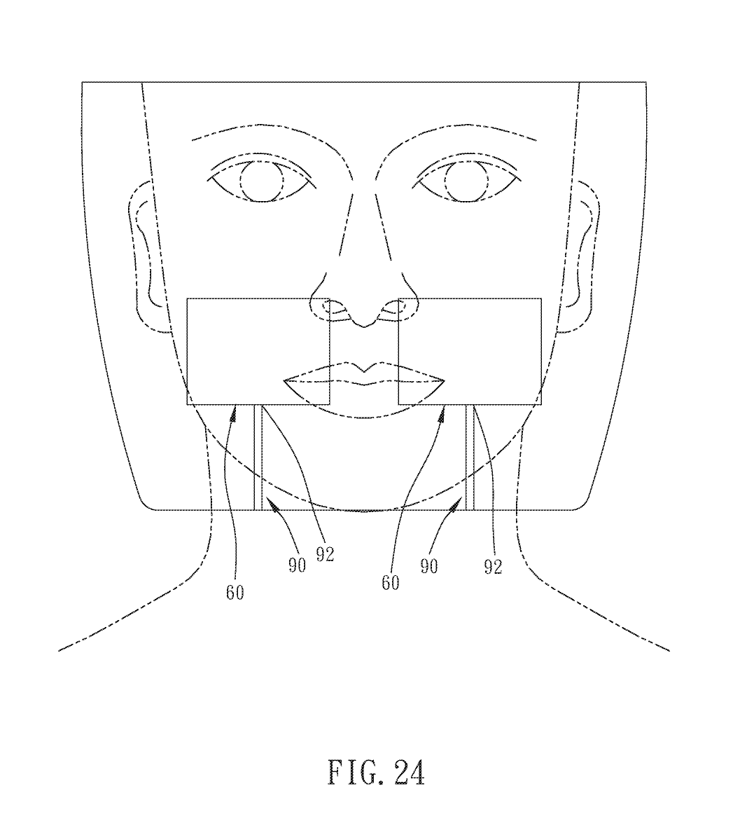

Referring then to FIG. 24, a head-mounted equipment capable of displaying images in accordance with the ninth embodiment of the present invention is similar to the seventh preferred embodiment, except that:

The quantity of the at least one bracket 90 is plural. In this embodiment, the quantity of the at least one bracket 90 is two as exemplary, each of the brackets 90 is provided with one connecting end 92, and the quantity of the at least one display 60 is also two, so that the two displays 60 are mounted on the two connecting ends 92 of the two brackets 90 to achieve the effect of projecting more images.

The rest structures of the ninth preferred embodiment are the same as the seventh preferred embodiment, and therefore, no further description seems necessary.

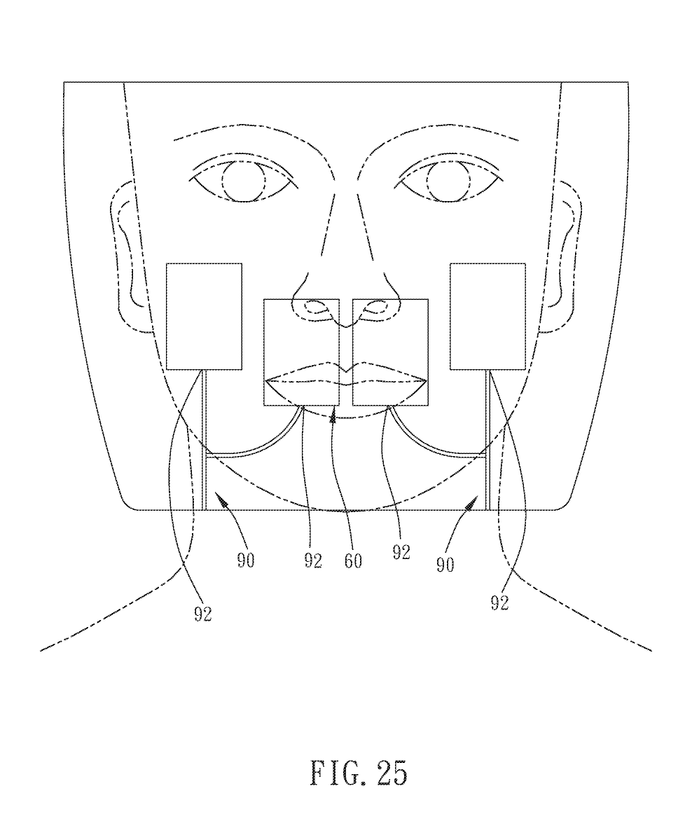

Referring then to FIG. 25, a head-mounted equipment capable of displaying images in accordance with the tenth embodiment of the present invention is similar to the seventh preferred embodiment, except that:

The quantity of the at least one bracket 90 is plural, and the quantity of the at least one connecting end 92 of each of the brackets 90 is also plural. In this embodiment, the quantity of the at least one bracket 90 is two as exemplary, and the quantity of the at least one connecting end 92 of each of the brackets 90 is also two, namely, each of the brackets 90 is provided with two connecting ends 92, so that four displays 60 are mounted on the four connecting ends 92 of the two brackets 90 to achieve the effect of projecting more images.

The rest structures of the tenth preferred embodiment are the same as the seventh preferred embodiment, and therefore, no further description seems necessary.

While we have shown and described various embodiments in accordance with the present invention, it is clear to those skilled in the art that further embodiments may be made without departing from the scope of the present invention.

What is claimed is:

1. A head-mounted equipment capable of displaying images, comprising:
a head-worn member with a front edge;
a visor attached to the front edge of the head-worn member, and being partially reflective and partially transparent, wherein the visor is arc-shaped and has a concave surface and a convex surface;
a face-worn member with a wearing surface and an opposite mounting surface; and
a display mounted on the mounting surface of the face-worn member to project an image to the visor.

2. The head-mounted equipment as claimed in claim 1 further comprising two ear-hook members provided at two sides of the face-worn member.

3. The head-mounted equipment as claimed in claim 2, wherein the two ear-hook members are two legs, each of the two legs has one end connected to the two sides of the face-worn member, and has another end formed with a hook portion.

4. The head-mounted equipment as claimed in claim 2, wherein the two ear-hook members are two rope rings.

5. The head-mounted equipment as claimed in claim 1, wherein the face-worn member includes an abutting layer and a substrate, the wearing surface is formed on an outer surface of the abutting layer, and the mounting surface is formed on an outer surface of the substrate.

6. The head-mounted equipment as claimed in claim 5, wherein the abutting layer of the face-worn member is made of silicone rubber.

7. The head-mounted equipment as claimed in claim 1, wherein the face-worn member is provided with two see-through apertures.

8. The head-mounted equipment as claimed in claim 1, wherein the visor is pivotally attached to the front edge of the head-worn member.

9. The head-mounted equipment as claimed in claim 1, wherein the display is configured to conform to a shape of the face-worn member.

10. A head-mounted equipment capable of displaying images, comprising:
a head-worn member with a front edge;
a visor attached to the front edge of the head-worn member, and being partially reflective and partially transparent, wherein the visor is arc-shaped;
at least one bracket with a fixing end and at least one connecting end, wherein the fixing end is fixed to the visor, and the at least one bracket extends from the fixing end toward a direction away from the visor to form the at least one connecting end; and
at least one display mounted on the at least one connecting end of the at least one bracket to project an image to the visor.

11. The head-mounted equipment as claimed in claim 10, wherein the visor has a first surface and an opposite second surface, the first surface is located toward the head-worn member, and the fixing end of the at least one bracket is disposed at the first surface of the visor.

12. The head-mounted equipment as claimed in claim 10, wherein there is one said bracket.

13. The head-mounted equipment as claimed in claim 12, wherein said bracket is provided with one said connecting end.

14. The head-mounted equipment as claimed in claim 12, wherein said bracket is provided with a plurality of said connecting ends.

15. The head-mounted equipment as claimed in claim 10, wherein there is a plurality of said brackets.

16. The head-mounted equipment as claimed in claim 15, wherein each of the brackets is provided with one said connecting end.

17. The head-mounted equipment as claimed in claim 15, wherein each of the brackets is provided with a plurality of said connecting ends.

18. The head-mounted equipment as claimed in claim 10, wherein the at least one bracket has flexibility.
